(19) United States
(12) Patent Application Publication
(10) Pub. No.: US 2023/0300561 A1
(43) Pub. Date: Sep. 21, 2023

(54) TRACKING DEVICE AND SYSTEM

(71) Applicant: Katch IP Pty Limited, Darlinghurst, New South Wales (AU)

(72) Inventors: Adam TRIPPE-SMITH, Darlinghurst, New South Wales (AU); Patrick HANRAHAN, Darlinghurst, New South Wales (AU); Marc EGGINS, Darlinghurst, New South Wales (AU); James YONG, Darlinghurst, New South Wales (AU)

(21) Appl. No.: 18/020,703

(22) PCT Filed: Aug. 10, 2021
(86) PCT No.: PCT/AU2021/050875

§ 371 Date: Feb. 10, 2023

(30) Foreign Application Priority Data
Aug. 10, 2020 (AU) 2020902818

(51) Int. Cl. H04W 4/021; H04W 4/02; G01P 15/18; G06Q 50/28

(52) U.S. Cl. CPC H04W 4/021; G01P 15/18; G06Q 50/28; H04W 4/027; G01K 1/16

(57) ABSTRACT

This invention relates to a tracking device for an object. The tracking device includes a motion detector that is attachable to the object. The motion detector is configured to collect a first data packet which is indicative of a movement of the object. A processing unit is operatively associated with the motion detector such that the processing unit can process the first data packet to determine whether the object is in one of an active state and a passive state. The processing unit can transmit a signal that is indicative of the state of the object to at least one gateway. Embodiments of the device or system may be configured to perform a method of tracking an object. The method includes the steps of: collecting a first data packet which is indicative of a movement of the object; processing the first data packet to determine whether the object is in one of an active state or a passive state; transmitting a signal indicative of the state of the object to at least one gateway; receiving an uplink signal from the at least one gateway to at least one server; and receiving a downlink signal from the server to a client application.

### FIELD OF THE INVENTION

The present invention relates to tracking devices. More particularly, the invention relates to devices for tracking the status and/or location of objects.

The invention has been developed primarily for use as a device for tracking the location of unpowered objects such as beer kegs as they move through a supply chain. While some embodiments will be described herein with particular reference to that application, it will be appreciated that the invention is not limited to such a field of use, and is applicable in broader contexts.

### BACKGROUND

The following discussion of the prior art is intended to facilitate an understanding of the invention and to enable the advantages of it to be more fully understood. It should be appreciated, however, that any reference to prior art throughout the specification in no way be considered as an admission that such art is widely known or forms part of common general knowledge in the field.

Beer kegs have always carried a high loss rate for producers due to the large volumes and distances that the kegs move throughout a market. Existing tracking options are labour intensive, such as manual barcode and RFID scanning for individual containers as they pass through checkpoints in the supply chain process. These require manual interaction with the asset to provide location data, leading to increased labour costs and inaccurate data due to human errors. Alternatively, existing active tracking units are not suitable and not designed for the lifecycle of a keg due to their short battery life in GPS technology or high subscription costs of 2G and 3G data networks. Current systems also do not allow for cost effective tracking over large coverage areas due to high roaming fees and increased battery depletion.

It is an object of the present invention to overcome or ameliorate at least one of the disadvantages of the prior art, or to provide a useful alternative. Embodiments of the device of the present invention have been designed to ameliorate the restrictions of existing devices by utilising a specific design for use on multiple kegs that allows the device to be replaced or upgraded at the end of its useful life. The device uses a 0G network, infrequent messaging and configuration of active and passive states, combined with a packet analyser for providing accurate geolocation data, extending battery life and reducing subscription costs.

### SUMMARY OF THE INVENTION

According to a first aspect of the invention, there is provided a tracking device for an object, the tracking device including:
a motion detector attachable to the object, the motion detector being configured to collect a first data packet which is indicative of a movement of the object; and
a processing unit operatively associated with the motion detector such that the processing unit can process the first data packet to determine whether the object is in one of an active state and a passive state;
wherein the processing unit can transmit a signal indicative of the state of the object to at least one gateway.

In some embodiments, the motion detector is an electromechanical device. In some embodiments, the motion detector includes an accelerometer. In some embodiments, the motion detector includes a gyroscope, a compass and/or an inertial measurement unit. In some embodiments, the accelerometer is configured to measure acceleration data of the object, thereby to collect the data which is indicative of the movement of the object. In some embodiments, the first data packet includes acceleration data. In some embodiments, the first data packet includes vibrational data. In some embodiments, the first data packet has a size in the range of 0 bytes to 12 bytes. In some embodiments, the accelerometer can measure the acceleration on at least one axis. In some embodiments, the accelerometer can measure acceleration on two axes. Preferably, the accelerometer measures acceleration on three axes. In some embodiments, each axis extends orthogonally to one another.

In some embodiments, the accelerometer is an AC-response accelerometer. In other embodiments, the accelerometer is a DC-response accelerometer. In some embodiments, the accelerometer may may be at least one of a capacitive accelerometer, a piezoresistive accelerometer, a laser accelerometer, an electromechanical servomechanism accelerometer, a bulk micromachined accelerometer, a pendulous integrating gyroscopic accelerometer, a potentiometric accelerometer, a surface acoustic wave accelerometer, and an optical accelerometer.

Preferably, the motion detector is attachable to the object such that movement of the object causes a corresponding movement of the motion detector. In some embodiments, the motion detector may be removably or fixedly attached to the object to be tracked. In some embodiments, the motion detector may be integrally formed with the object.

In some embodiments, the processing unit is a signal processing unit. Preferably, the signal processing unit is adapted to transmit and/or receive one or more signals, wherein predetermined data is associated with each signal. In some embodiments, the processing unit includes an antenna in communication with the signal processing unit, the antenna being configured to transmit and/or receive the signals to and from the signal processing unit. In some embodiments, the processing unit is configured to process the first data packet to determine whether the object is in one of an active state and a passive state. In some embodiments, the processing unit determines whether the object is in one of an active state and a passive state based on a predefined threshold. In some embodiments, the processing unit may be configured to process a plurality of data packets. In some embodiments, the processing unit may form at least part of a mainboard.

In some embodiments, the motion detector is configured to detect a plurality of movement types. In some embodiments, the active state is determined by at least one movement of the object detected by the motion detector. In some embodiments, the at least one movement triggers a signal including the first data packet. In some embodiments, the at least one movement is at least one of a translational movement, a rotational movement or a tilting movement.

In some embodiments, the active state defines or indicates that the object is moving, or an event is occurring in which the object is involved. In some embodiments, the processing unit is configured to transmit a signal indicative of the active state of the object to at least one gateway. In some embodiments, the signal is transmitted to a plurality of gateways. In some embodiments, the signal is transmitted at a predefined active interval. In some embodiments, the predefined active interval is set by the user. The active interval may be a regular or irregular interval.

Preferably, the motion detector is configured to detect a plurality of movement types. In some embodiment, the motion detector is configured to detect, and differentiate between, a first movement type, a second movement type and a third movement type.

In some embodiments, the movement detected by the motion detector is a first movement type such as a linear or rotational displacement or other translational movement. In some embodiments, the translational movement is detected when an acceleration is at or above a first threshold for more than a first discrete period of time. In some embodiment, a first translational movement threshold is in the range of 60 milli-g to 90 milli-g. In some embodiments, the first translational movement threshold is 78 milli-g. In some embodiments, the first period of time is in the range of 5 seconds and 15 seconds. In some embodiments, the first period of time may be 10 seconds. In some embodiments, the first period of time may be 10 seconds in the last 60s.

In some embodiments, the movement detected by the motion detector is a second type of movement such as a rotational movement. In some embodiments, the rotational movement is detected when the motion detector measures a rotation defined between a predetermined minimum angle and a predetermined maximum angle. In some embodiments, the rotational movement may be detected when the motion detector measures a rotation compared to a rotational angle of reference. In some embodiments, a rotational movement minimum angle may in the range of 0 degrees and 90 degrees. Preferably, the minimum angle is 25 degrees. In some embodiments, a rotational movement maximum angle may be between 45 and 360 degrees. Preferably, the maximum angle is 65 degrees. In some embodiments, the rotation angle is calculated based on the rotational angle of reference. In some embodiments, the rotational angle of reference is set during a calibration phase. In some embodiments, the rotational angle of reference is 0 degrees.

In some embodiments, the movement detected by the motion detector is a third type of movement such as a tilting movement. In some embodiments, the tilting movement is detected when the motion detector measures a tilt compared to a tilting reference angle. In some embodiments, the tilting movement may be detected when the tilt is between a predetermined minimum angle and a predetermined maximum angle compared with the tilting reference angle. In some embodiments the tilt is a rotation of 180 degrees. In some embodiments, the tilting reference angle is set during a calibration phase. In some embodiments, the tilting reference angle is 0 degrees.

In some embodiments, at least one movement can trigger the processing unit to transmit a signal including the first data packet, indicating the object is in an active state. In some embodiments, the translational movement does not trigger a signal. In some embodiments, the rotational movement triggers a signal. In some embodiments, the rotational movement triggers a signal immediately upon detection. In some embodiments, there is a minimum interval between two signals triggered by a rotational event. In some embodiments, the minimum interval is an event delay interval, configured to delay the timing between events which may trigger a change between an active state or passive state. In some embodiments, the event delay interval is 10 minutes. In some embodiments, the tilting movement does not trigger a signal. In some embodiments, the tilting movement may trigger a signal when combined with other movements and/or measurements.

In some embodiments, the passive state is determined when the motion detector detects no movement of the object. In some embodiments, the passive state is determined when the motion detector detects movements compared with a predefined threshold.

In some embodiments, the passive state triggers a signal indicative of the passive state of the object to at least one gateway. In some embodiments, the signal is transmitted to a plurality of gateways. In some embodiments, the signal is transmitted at a predefined passive interval. In some embodiments, the predefined passive interval is set by the user. In some embodiments, the predefined passive interval is 1 day. In some embodiments, the detection of a movement by the motion detector triggers the active state. In some embodiments, the detection of a movement by the motion detector stops or resets the passive interval.

In some embodiments, when the object is in the passive state it can switch to the active state in response to at least one type of movement. In some embodiments, the at least one type of movement includes the translational movement, the rotational movement and/or the tilting movement. In some embodiments, the object switches from a passive state to an active state in response to (e.g. immediately after detecting) a translation movement or tilting movement by triggering an active state. In some embodiments, the object switches from a passive state to an active state immediately after detecting a rotational movement. In some embodiments, the object switches from an active state to a passive state after the motion detector detects no movement for a predetermined delay period. In some embodiments, the predetermined delay period is set by the user. In some embodiments, the predetermined delay period is 30 minutes. In some embodiments, the active interval must finish before the passive interval can begin. In some embodiments, if a movement is detected during the delay period, the delay period is stopped and the object remains in the active state.

In some embodiments, a pattern of active states and passive states may be used to define or otherwise be indicative of an event. In some embodiments, an event has an individual state profile. In some embodiments, the registration of an event may trigger the processing unit to transmit an event signal to the gateway, indicative of the type of event to have occurred. In some embodiments, for example, the event is a cleaning event. In some embodiments, the event signal may include time and/or location information. In some embodiments, the cleaning event includes collecting a second data packet indicative of the temperature data. In some embodiments, the cleaning event triggers the collection of temperature data.

In some embodiments, the device includes a sensor attached to the object, the sensor being configured to collect a second data packet including data or information representative of one or more characteristics of the object and/or one or more parameters associated with a condition of the environment in which the object is located. In some embodiments, the sensor is a temperature sensor. More preferably, the second data packet is indicative of a temperature of the object. In some embodiments, the second data packet is indicative of an environmental temperature. In some embodiments, the sensor may be at least one of a humidity sensor, a light sensor, an air flow sensor, a speed sensor, a gyroscope, an inclinometer, and a tilt sensor. In some embodiments, the sensor is operatively associated with the processing unit such that the processing unit can process the second data packet and transmit a signal to at least one gateway. In some embodiments, the signal includes the second data packet. In some embodiments, the sensor is connected to the processing unit by a flexible printed cable (FPC). In some embodiments, the sensor may be in the form of a sensor board.

In some embodiments, the processing unit is configured to obtain location information about the object. In some embodiments, the processing unit includes a packet analyser, configured to obtain geolocation information about the object. In some embodiments, the packet analyser is a wireless sniffer. In some embodiments, the device includes a packet analyser operatively associated with the processing unit.

In some embodiments, the packet analyser collects geolocation information by detecting at least one media access control (MAC) address. In some embodiments, the packet analyser detects at least one MAC address and at least one associated received signal strength indicator (RSSI). In some embodiments, the processing unit can transmit a location signal indicative of the location of the object. In some embodiments, the processing unit transmits a geolocation signal based on a comparison of RSSI values of identified MAC addresses. In some embodiments, the processing unit transmits a location signal based on a comparison of identified MAC addresses with at least one historical MAC address. In some embodiments, the location signal includes at least one MAC address. Preferably, the location signal includes two MAC addresses. In some embodiments, the processing unit is configured to collect the geolocation information as a third data packet which is indicative of a physical location of the object. In some embodiments, the location signal and/or the third data packet is included in the signal transmitted to the at least one gateway.

In some embodiments, the MAC addresses are access point MAC addresses. In some embodiments, the access point may be a fixed access point. In some embodiments, the access point may be a mobile access point. In some embodiments, the access point may be a wired access point. In some embodiments, the access point may be a wireless access point. In some embodiments, an access point may be one of a standalone access point, a multifunction access point or a controlled access point. In some embodiments, the controlled access point may be a lightweight access point. In some embodiments, the MAC address is a device MAC address. In some embodiments, the MAC address is a WiFi MAC address. In some embodiments, the MAC address is associated with a WiFi access point. In some embodiments, the MAC address may be associated with a wireless router, a hub, a switch, a laptop, a tablet or a smartphone.

In some embodiments, the processing unit transmits the signal through a low power wide area network. In some embodiments the network is a 0G network. In some embodiments, the signal is an Ultra Narrow Band (UNB) signal, transmitted at substantially infrequent intervals to reduce signal interference. In some embodiments, the low power wide area network may be a non-cellular network. In some embodiments, the low power wide area network may be an unlicensed or license free low power wide area network. In some embodiments, the low power wide area network may utilise the Sigfox network. In some embodiments, the low power wide area network contains a plurality of zones. In further embodiments, the plurality of zones are radio configuration zones. In some embodiments, the low power wide area network supports all Sigfox Zones within the Sigfox network. In some embodiments, Sigfox Zones may also be referred to as radio configuration zones. In further embodiments, the device operates with Class 0u certification of radio frequency performance for at least one radio configuration zone. In other embodiments, the device operates with Class 0u certification of radio frequency performance for radio configuration zones 1, 2, and 4. In another embodiments, the device operates with Class 0u certification of radio frequency performance for all radio configuration zones.

In some embodiments, the processing unit includes an antenna to transmit the signal to the gateway. In some embodiments, the antenna is optimised for Class 0u of radio frequency performance on Radio Configuration Zones 1, 2, and 4. In other embodiments, the antenna is optimised for Class 0u of radio frequency performance on all Radio configuration Zones. Preferably, the gateway is a base station having a UNB receiver. In some embodiments, the signal is transmitted to a plurality of gateways. In some embodiments, the signal is transmitted to the gateway as an uplink signal. In some embodiments, the gateway performs an interference reduction process on the uplink signal. In some embodiments, the interference reduction process includes demodulating the uplink signal. In some embodiments, the gateway utilises Differential Phase Shift Keying (DPSK) to demodulate the uplink signal. In some embodiments, the gateway transmits the signal to a server. In some embodiments, the server is a cloud server. In some embodiments, the server is configured to receive demodulated signals from the gateway. In some embodiments, the sever includes a database, configured to store the uplink signals. In some embodiments, the server includes a back-end server. In some embodiments, the server includes a front-end server. In some embodiments, the server transmits a downlink signal to a client application. In some embodiments, the downlink signal is a downstream transmission, In other embodiments, the downlink signal is a download transmission. In yet further embodiments, the downlink signal may be referred to as a downstream signal or a download signal. In some embodiments, the downlink signal is decoded payload data. In one embodiment, the decoded payload data is in data-interchange format. In some embodiments the data interchange format is JSON or XML. In further embodiments, the downlink signal may include at least one of: a downlink configuration message, a downlink request message or a downlink acknowledgement message. In some embodiment the downlink signal and the uplink signal use substantially different frequencies. In some embodiments, the client application includes a smartphone application. In some embodiments, the client application includes a web application. In some embodiments, the server transmits a downlink signal to the gateway. In some embodiments, the downlink signals use Frequency Shift Keying (FSK) to reduce interference in the downlink signal when received by the client application.

In some embodiments, the processing unit is configured to log object data. In some embodiments, object data preferably includes at least one of timestamps, washing cycles, temperature, tilt events, and acceleration. In further embodiments, object data includes movement data. In some embodiments, object data is logged and stored on the client application. In some embodiments, the object data is logged for at least 90 days. In further embodiments, the object data is logged for at least 12 months. In some embodiments, all object data is logged. In another embodiment, object data logs may be obtained via WiFi. In other embodiments, object data logs may be accessible through the client application.

In some embodiments, the device includes a tag, configured to connect with a client application. In some embodiments, the tag is configured to enable a wireless connection with the client application. In some embodiments, the tag is an NFC tag. In some embodiments, the NFC tag includes unique identifying information. In some embodiments, the NFC tag can be used for calibration of the tracking device. In some embodiments, the NFC tag can be used to set parameters and/or thresholds for the device. In other embodiments, the device includes Bluetooth connectivity. In some embodiments, the wireless connection with the client application can be used to update firmware. In other embodiments, the wireless connection with the client application can be used to update firmware across a plurality of proximal devices.

In yet further embodiments, the device is configured to switch between radio configuration zones to enable tracking between different zones within the low power wide area network (e.g. global roaming). In one embodiment, the device is configured to perform zone switching. In some embodiments, the device is configured to scan a specific frame broadcasted by compatible gateways and change its zone configuration to match the zone of nearby gateways. In further embodiments, the zone switching may be performed using a scanning system which utilizes dedicated hardware and software. In some embodiments, the device may utilise a chip-on-board structure. In other embodiments, zone switching may be performed manually through the client application. In another embodiment, the client application may be used to select the destination zone for the zone switching. In one embodiment, zone switching is performed using the NFC tag and the client application. In some embodiments, zone switching may be manually set to occur on a particular date. In other embodiments, zone switching may be manually set to occur within a predetermined time frame. In some embodiments, the manual zone switching may be configured to broadcast a signal to change a zone configuration of proximal devices.

In other embodiments zone switching may be performed via downlink. In one embodiment, the destination zone and the date are set at a software level. In some embodiments the device is triggered to perform zone switching at the downlink interval. In further embodiments, zone switching may be performed via a WiFi beacon. In some embodiments, the zone switch is triggered on receipt of a signal broadcast from the WiFi beacon.

In some embodiments, the client application is enabled to activate or deactivate the tracking device. In some embodiments, the client application can be used to calibrate the tracking device. In some embodiments, the client application can manually trigger at least one of a downlink signal, an uplink signal, a temperature signal, a location signal and an event signal.

In some embodiments, the device includes a housing. In some embodiments, the housing forms an enclosure around at least the motion detector and the processing unit. In some embodiments, the housing is substantially rectilinear. In other embodiments, the housing is substantially capsule-shaped. In some embodiments, the housing includes an upper housing and a lower housing. In some embodiments, the upper housing is substantially rectilinear and the lower housing is substantially planar, forming a base. In other embodiments, the upper housing is substantially semi-capsule shaped. In another embodiment, the lower housing is substantially semi-capsule shaped. In further embodiments, the lower housing has a flat base. In some embodiments, the upper housing and the lower housing may be substantially the same shape. In some embodiments, the upper housing and the lower housing are attachably detachable from one another.

In some embodiments, the housing is configured to be removably attachable to the object. The housing may be directly or indirectly mounted to the object. In some embodiments, the housing has at least one tab extending from the housing, configured for affixing the housing to the object. In some embodiments, the at least one tab is configured for affixing the housing to a mount. In some embodiments, the housing has a pair of tabs, each extending from the housing, configured for affixing the housing to a mount. Preferably, the at least one tab extends from a base of the housing. In some embodiments, each tab of the pair of tabs are located at opposite ends of the housing. In some embodiments, the tabs are located on the upper housing. In some embodiments, a first pair of tabs are located on the ends of the lower housing and a second pair of tabs are located on the ends of the upper housing, the first pair of tabs and second pair of tabs being connectable with each other. In some embodiments, the first pair of tabs each include a first aperture and the second pair of tabs each include a second aperture, the first apertures and the second apertures configured to align when the tabs are connected and/or come into abutting engagement. In some embodiments, the second apertures include a thread. In other embodiments, the housing has a peripheral tab extending from the housing, configured for affixing the housing to a mount. In some embodiments, the peripheral tab extends continuously about a periphery of the upper and/or lower housing.

In some embodiments, the housing includes a reservoir defining a thin portion to accommodate an LED light. In some embodiments, the LED light is visible through the material of the housing. In one embodiment, operation of the LED light is used to indicate a low battery. In another embodiment, the LED light is displayed when the object is moving. In one embodiment, the active state is used to trigger the display of the LED light. In another embodiment, the detection of a movement type is used to trigger the display of the LED light. In another embodiment, the thin portion is surrounded by a plurality of ribs. In further embodiments, the plurality of ribs are disposed in parallel.

In some embodiments, the housing may include an aperture configured to accommodate a sensor. In some embodiments, the sensor is received in, or otherwise aligned with, the aperture such that the sensor is exposed to the surrounding environment. In some embodiments, the aperture may be enclosed by a metal cover.

In some embodiments, the mount is configured to be fixedly attached to the object. In some embodiments, the mount is configured to be fixedly welded to the object. Preferably, the mount is a substantially u-shaped bracket. In some embodiments, the u-shaped bracket includes a pair of spaced side legs, interconnected by a bridging portion. In some embodiments, the bridging portion is substantially the same length as the housing. In some embodiments, the housing is removably attachable to the mount. In some embodiments, the housing is removably attached to the bridge portion of the mount. In some embodiments, the spaced side legs are configured to be welded to the container. The mount is preferably configured such that when the housing is attached thereto, the housing is spaced from (e.g. upwardly above) the surface of the object to which the device is attached.

In yet further embodiments, the mount may be a bracket. In one embodiment, the bracket includes two interlocking parts. In one embodiment, the two interlocking parts may be a pair of substantially L-shaped interlocking brackets. The L-shaped brackets preferably have at least one aperture to facilitate interlocking. In further embodiments, the bracket is removably attachable from an object. In further embodiments, the bracket is adapted to be installed in a keg’s peripheral rim. In one embodiment, the bracket is adapted to be interference fit or press fit into a peripheral rim of keg. In another embodiment, the two interlocking parts are secured together with at least one securing mechanism. In some embodiments, the securing mechanism is configured to move the two interlocking parts in opposing directions to provide an interference fit between the mount and the object. In some embodiments, the securing mechanism includes at least one screw. In one embodiment, the two interlocking parts are secured together using a pair of screws. In some embodiments, the securing mechanism acts as an adjustable spacer. In further embodiments, the bracket is height adjustable. In some embodiments, the two interlocking parts are configured to fit together to provide a mounting surface on which the tracking device can be attached. In some embodiments, the mounting surface is spaced apart from the surface of the object to define a gap. In other embodiments, a first thermal pad may be placed within the housing of the device, underneath the temperature sensor. In some embodiments, the first thermal pad may be placed above the metal cover in the base of the lower housing. In some embodiments, the metal cover may be substantially rectilinear. Preferably, the metal cover is substantially square-shaped. In further embodiments, a second thermal pad may be placed underneath the metal cover to fill the base of the lower housing. In some embodiments, the second thermal pad may be placed underneath the metal cover and above the mounting surface. In other embodiments, the second thermal pad may be in contact with the metal cover and the object. In further embodiments, the gap is filled with an external thermal pad to allow thermal transfer between the device and the object. In some embodiments, the first and second thermal pads are smaller than the external thermal pad. In further embodiments, the bracket applies pressure on the external thermal pad to secure the pad in place.

In further embodiments, the bracket may include a substantially U-shaped bracket. In some embodiments, the bracket is configured to be fastened to the object using a flexible member fastening element (e.g. cable tie). In other embodiments, the housing may be directly attached to the object using a chemical fastener (e.g. an adhesive). In some embodiments, the adhesive includes double-sided tape. In some embodiments, the double-sided tape is 3 M VHB tape. In some embodiments, the device may not be removed from the mount or the object without a special tool or excessive force. In other embodiments, the mount may not be removed from the object without a special tool or excessive force. In yet another embodiment, the device is mounted such that is protected against 20 joules of impact. Preferably, the device is mounted such that is meets an IK10 impact protection rating.

In some embodiments, the device is attached to an external surface of the object. In some embodiments, the device is attached to a side of the object. In some embodiments, the device is attached to a base of the object. In some embodiments, the device is attached to a top of the object. In some embodiments, the device is attached to the top or upper surface of a keg, wherein the keg has an upper peripheral rim bounding the top surface. In some embodiments, the upper peripheral rim of the keg extends from the top surface of the keg by a predetermined distance. Preferably, the device is mounted to the top surface of the keg such that the device sits below the extreme or distal end of the rim. In this way, a plurality of kegs can be stacked vertically, one on top of the other, in such a manner that the base of one keg does not interfere with the device attached to the top surface of the keg immediately below in the stack of kegs. In some embodiments, the device is configured to be mounted on at least one of a 20 L keg, a 30 L keg, or a 50 L keg.

In some embodiments, the peripheral rim includes one or more openings. In some embodiments, the one or more openings in the peripheral rim may facilitate airflow across the device when a plurality of kegs are arranged in a vertical stack. In some embodiments, peripheral rim includes two openings arranged on opposite sides of the rim. In some embodiments, the housing of the device may be mounted to the top surface of the keg such that its longitudinal axis is aligned with, or parallel to, a line extending between the two openings. In some embodiments, the housing of the device may be mounted to the top surface of the keg such that its longitudinal axis is angled relative to, preferably orthogonal to, a line extending between the two openings. By mounting the housing / device between the openings, a passage for airflow across the device is provided and visual inspection of the device through the apertures is advantageously facilitated. Furthermore, the passageway provided by the handles also advantageously facilitates a relatively unobstructed pathway for wireless communication of signals to and from the processing unit / device, particularly when a plurally of objects (e.g. kegs) are vertically stacked.

In some embodiments, the device includes a power module. Preferably, the power module is a battery. In some embodiments, the power module is an A size battery. In some embodiments, the A size battery is a lithium battery. In some embodiments, the power module is connected to the processing unit via a connector, to facilitate connection and disconnection of the power module.

According to another aspect of the invention, there is provided a tracking device for a container, including:
a housing;
a mainboard disposed within the housing, the mainboard having an antenna configured to transmit data to at least one gateway, the data indicating location information of the container; and
an accelerometer disposed within the housing and connected to the mainboard; and
a power module connected to the mainboard, for providing power to the device.

A system for tracking an object, the system including:
a tracking device including:
   a motion detector attachable to the object, the motion detector being configured to collect a first data packet which is indicative of a movement of the object; and
   a processing unit operatively associated with the motion detector such that the processing unit can process the first data packet to determine whether the object is in one of an active state and a passive state;
   wherein the processing unit can transmit a signal indicative of the state of the object to at least one gateway;
at least one server in communication with the at least one gateway, the server configured to receive an uplink signal from the at least one gateway; and
a client application in communication with the server, the terminal device configured to receive a downlink signal from the server.

A method for tracking an object, the method including the steps of:
a) collecting a first data packet which is indicative of a movement of the object;
b) processing the first data packet to determine whether the object is in one of an active state or a passive state;
c) transmitting a signal indicative of the state of the object to at least one gateway;
d) receiving an uplink signal from the at least one gateway to at least one server; and
e) receiving a downlink signal from the server to a client application.

### BRIEF DESCRIPTION OF THE DRAWINGS

Preferred embodiments of the disclosure will now be described, by way of example only, with reference to the accompanying drawings in which:

FIG. 1 shows a schematic representation of an embodiment of network architecture for a system for tracking an object;

FIG. 2 is a flowchart showing the data flow paths between various elements of the system for tracking an object;

FIGS. 3A and 3B show an embodiment of an unpowered object in the form of a keg, and an embodiment of a tracking device which is attachable to the keg, respectively;

FIGS. 4A and 4B respectively show a perspective top view and a top view of a keg on which a tracking device has been attached to its upper surface;

FIGS. 4C and 4D respectively show a perspective top view and a top view of a slim keg on which a tracking device has been attached to its upper surface;

FIGS. 5A to 5D show diagrams representative of four scenarios of tracking active and passive states of an object, respectively

FIG. 6 shows a schematic representation of a further embodiment of network architecture for a system for tracking an object;

FIG. 7 shows a schematic representation of a further embodiment of network architecture for a system for tracking an object, showing data uplink/downlink using a WiFi network;

FIGS. 8A and 8B show perspective front views of embodiments of the mount including a pair of interlocking brackets suitable for 20L/30L kegs and 50L kegs, respectively; and

FIG. 9 shows a cross-sectional view of an embodiment of the device mounted to an object, showing the thermal pad locations.

### DETAILED DESCRIPTION

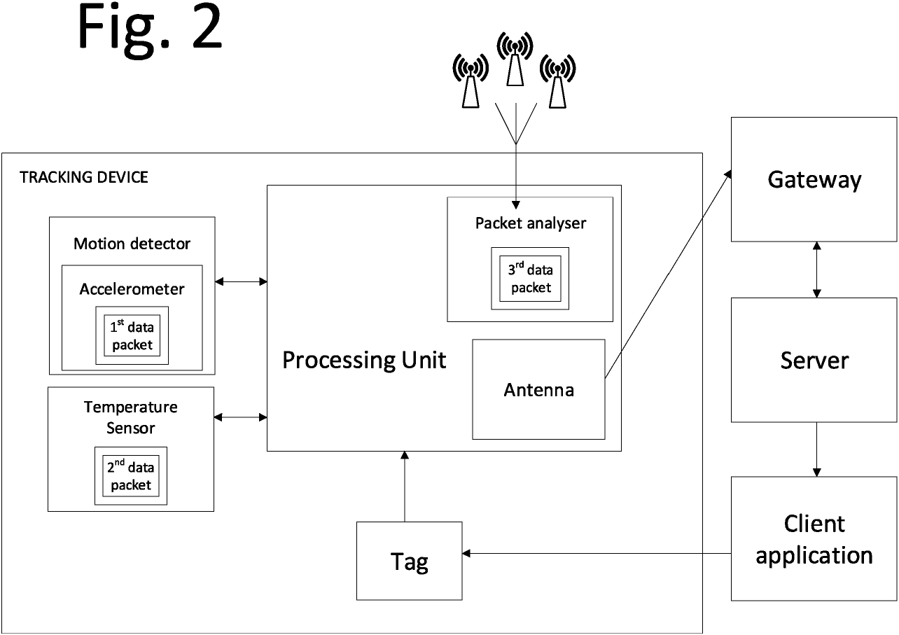

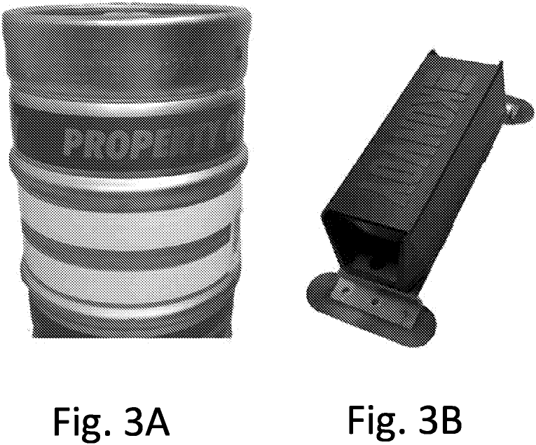

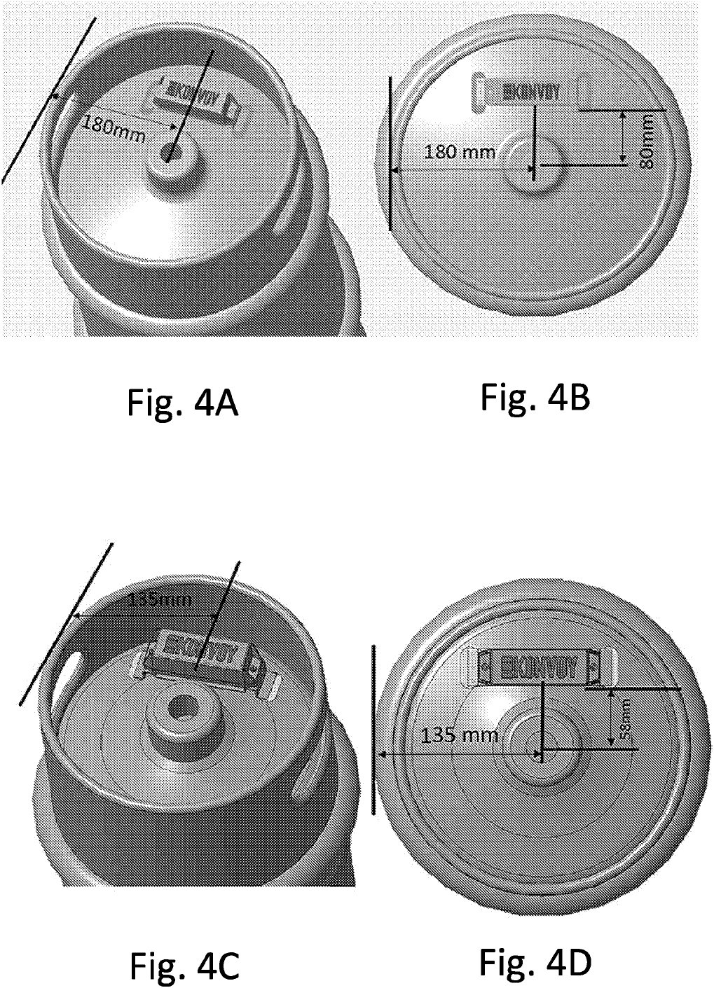

Referring initially to FIG. 2, a tracking device is described. The device includes a motion detector attachable to an object. The motion detector is configured to collect a first data packet indicative of a movement of the object. The device also includes a processing unit. The processing unit is operatively associated with the motion detector such that the processing unit can process the first data packet to determine whether the object is in an active state or a passive date. The processing unit is further configured to transmit a signal indicating the state of the object to at least one gateway.

In its preferred form, the tracking device is used to track a container through a supply chain. Although embodiments of the invention in the following description will be described with reference to tracking a container in the form of a keg through a supply chain, it will be appreciated that the tracking device can be used to track any objects including, but not limited to, skip bins, drums, rental tools and equipment, bulk containers, grain bins, pallets, boxes, and the like. As will become apparent from the following description, the tracking device is particularly advantageous for tracking the status and/or location of an unpowered object.

### Overview

In overview, the tracking device includes a motion detector attachable to the container. The motion detector is an electromechanical device and includes an accelerometer. The accelerometer is configured to measure an acceleration of the container to collect acceleration data for a first data packet. A processing unit operatively associated with the motion detector processes the first data packet to determine whether the object is in one of an active state and a passive state. The processing unit can then transmit a signal indicative of the state of the container, via an antenna, to a plurality of base stations.

In a preferred embodiment of a tracking system, which utilises one or more of the tracking devices, the base station demodulates the received signal and transmits the demodulated signal to a cloud server. The cloud server then transmits a downlink signal to a client application, such as a smartphone app or web browser, thereby enabling a user to view the state and location of the container.

### Motion Detector

The motion detector may be an electromechanical device. The electromechanical device may include an accelerometer, a gyroscope, a compass, or an inertial measurement unit. In a preferred embodiment, the motion detector is an electromechanical device which includes an accelerometer. The accelerometer is configured to measure acceleration data of the object on three axes. However, it will be appreciated that a one axis or dual axis accelerometer or combination of accelerometers may be used. Acceleration data is measured in natural units of the standard acceleration due to gravity including g or milli-g units. However, the accelerometer may measure acceleration data in SI units, such as meters per second squared. The accelerometer may also be configured to measure vibrational data. The acceleration measurements are collected by the accelerometer in a first data packet.

The accelerometer may be an AC-response or a DC-response accelerometer. In further embodiments, the accelerometer may include, but is not limited to, a capacitive accelerometer, a piezoresistive accelerometer, a laser accelerometer, an electromechanical servomechanism accelerometer, a bulk micromachined accelerometer, a pendulous integrating gyroscopic accelerometer, a potentiometric accelerometer, a surface acoustic wave accelerometer, an optical accelerometer, or any combination of such accelerometers.

The motion detector is attachable to an object to be tracked such that movement of the object causes a corresponding movement of the motion detector. In some embodiments, the motion detector is attached such that it can be removed easily for cleaning, maintenance, repair, replacement, upgrade and the like. The motion detector may be fixedly attached to the object to be tracked. Alternatively, the motion detector may be integrally formed with the object, or stored within a particular location on the object itself, such as a compartment formed on the object.

### Processing Unit

As shown in FIG. 2, the processing unit is operatively associated with the motion detector. In a preferred embodiment, the processing unit is a signal processing unit, which includes an antenna. The antenna may be configured or optimised for Class 0u of radio frequency performance on all Radio Configuration Zones of the Sigfox network, or preferably Radio Configuration Zones 1, 2, and 4. The processing unit is preferably configured to transmit and receive signals/data. The processing unit processes the first data packet collected by the accelerometer. It will be appreciated that the processing unit may be configured to process a plurality of data packets, either simultaneously or iteratively. In further embodiments, the processing unit may form at least part of a mainboard or motherboard. Additionally, the processing unit may be operatively associated with a plurality of motion detectors or additional sensors.

The processing unit processes the first data packet to determine a state of the object using the accelerometer data. The state includes, but is not limited to, one of an active state or a passive state. The processing unit determines the state by comparing the accelerometer data from the first data packet against a predefined threshold. In some embodiments, the processing unit may utilise a single predetermined threshold for determining a single state. Alternatively, the processing unit may utilise a plurality of predetermined thresholds for a single state, for example, a minimum and a maximum threshold. In yet further embodiments, the processing unit may utilise multiple predetermined thresholds for determining multiple states or a single predetermined threshold for multiple states.

### Active and Passive States

In the preferred embodiment, there are two main states for a container being tracked through a supply chain - an active state and a passive state.

The active state is determined by at least one movement of the object being detected by the motion detector. An active state suggests that the object is moving or some kind of event (e.g. a change in a characteristic of the object itself and/or a surrounding environmental parameter such as, for example, a change in temperature) is occurring in which the object is involved. The movement of the object may be a translation movement, a rotational movement or a tilting movement.

A first movement type such as a linear or rotational displacement or other translational movement is detected when an acceleration is at or above a first threshold for more than a first period of time. The translational movement is detected by acceleration in the xyz plane. This type of movement may be referred to herein as a “T0” movement. For example, when a container to be tracked, such as a keg, is moving for a first period of time, the movement is registered as a translational movement or a T0 movement. The first period of time is a first predetermined discrete period. In one embodiment, a first translational movement threshold may be between 60 milli-g to 90 milli-g. Preferably, the threshold is 78 milli-g. The first period of time is in the range of 5 seconds and 15 seconds. Preferably, the first period of time is 10 seconds. Additionally, the period of time may be required to have occurred within a predefined historic duration of time. For example, the first period of time may be 10 seconds, but must have occurred within the last 60 seconds.

A second type of movement such as a rotational movement is detected when a rotation of the object, and corresponding rotation of the motion detector, occurs. The rotational movement may be detected, and a signal generated to indicate such movement, when the motion detector measures a rotation compared to a rotational angle of reference. The rotational movement may be detected when the rotation is between a predetermined minimum angle and a predetermined maximum angle. This type of movement may be referred to herein as a “T30” movement. For example, when an object to be tracked, such as a keg, is rotated about an axis parallel to the gravitational force, the movement is registered as a rotational movement or T30 movement. A rotational movement minimum angle may be between 0 degrees and 90 degrees. In one embodiment, the minimum angle is 25 degrees. A rotational movement maximum angle may be between 45 and 360 degrees. In one embodiment, the maximum angle is 65 degrees. The rotational angle is calculated based on the rotational angle of reference. The rotational angle of reference may be set during a calibration phrase, and preferably is selectively updatable as required to suit a particular application or the type of object to be tracked. The rotational angle of reference may be selectively and/or manually set by a user. In a preferred embodiment, the rotational angle of reference is 0 degrees.

A third type of movement such as a tilting movement is detected when the object, and corresponding motion detector, is tilted. The tilting movement may be detected when the motion detector measures a tilt or tilt angle of the object compared to a tilting reference angle. The tilting movement may be detected when the tilt is between a predetermined minimum angle and a predetermined maximum angle compared with the tilting reference angle. This type of movement may be referred to herein as a “T180” movement. For example, when an object to be tracked, such as a keg, is rotated about an axis perpendicular to the gravitational force, the movement is registered as a tilting movement or T180 movement. In some embodiments, the tilting movement is a rotation of 180 degrees. The tilting reference angle may be set during a calibration phase, and preferably is selectively updatable as required to suit a particular application or the type of object to be tracked. The tilting reference angle may be selectively and/or manually set by the user. In a preferred embodiment, the tilting angle of reference is 0 degrees.

Each of the translational, rotational and tilting movements can trigger the processing unit to transmit a signal including the first data packet. The signal indicates that the state of the object is in an active state. For example, the active state may arise when the translational movement and the tilting movement does not trigger a signal, but the rotational movement does trigger a signal. In some cases, the rotational movement triggers a signal immediately upon detection. There may be a minimum interval between two signals triggered by a rotational movement, or a rotational event. For example, this minimum interval could be a period of 10 minutes. The minimum interval can be an event delay interval, configured to delay the timing between events which may trigger a change between an active state or passive state. In other embodiments, the tilting movement may trigger a signal when combined with other movements and/or measurements.

The passive state is determined when the motion detector detects no movement of the object. A passive state defines that the object is not moving, or has ceased moving for a certain period of time. In some embodiments, the passive state is determined when the motion detector detects no movements compared with a predefined threshold. The passive state triggers the processing unit to transmit a signal to a gateway indicating that the object has entered a passive state. During the passive state, the signal is transmitted at a predefined passive interval. The passive interval may be set by the user. For example, the predefined passive interval may be a predetermined period of time set in seconds, minutes, or days such as a predefined interval of 1 day.

Once the motion detector detects a movement, the processing unit stops the passive interval and triggers an active state. When the object is in a passive state, it can switch to the active state by the motion detector registering at least one type of movement, such as a rotational, translational or tilting movement. The object switches from a passive state to an active state immediately after detecting a translational or tilting movement, causing the processing unit to transmit a signal indicating an active state to a gateway. Alternatively or additionally, the object switches from a passive state to an active state immediately after detecting a rotational movement. However, it will be appreciated that in some embodiments, the object may switch from a passive state to an active state only if a predetermined threshold of movement is reached, thereby reducing false triggering of an active state due to minor movements.

In yet further embodiments, the object may switch from an active state to a passive state after the motion detector detects no movement within a predefined threshold for a predetermined delay period. The predetermined delay period may be selectively set by the user. In a preferred embodiment, the predetermined delay period is 30 minutes. The active interval must finish before the passive interval can begin. Alternatively, or additionally, if a movement is detected during the delay period, the delay period is stopped and the object remains in the active state.

The active state and passive state can be used to track specific events while tracking an object. For example, specific patterns of switching between active and passive states of an object can be stored in a memory used to register the occurrence of specific events. As an example, when tracking a keg, events which occur during the supply chain could include “travelling”, “cleaning”, “loading”, “in storage” and the like. Each event may have a state profile. The occurrence or registration of an event may trigger the processing unit to send an event signal to the gateway, indicating the type of event to have occurred. The event signal may include additional event information such as the time, location and measurements made during the event.

In a preferred embodiment, the motion detector is attached to a keg being tracked through a supply chain. The motion detector is configured to detect movement of the keg as it is transported through different locations, stored in warehouses and the like. There is now described a number of scenarios in which movement of the keg is detected and active and passive states are used to track the keg through a supply chain. However, it will be appreciated that these scenarios are being used by way of example only, and are not intended to limit the use of the tracking device to containers such as kegs.

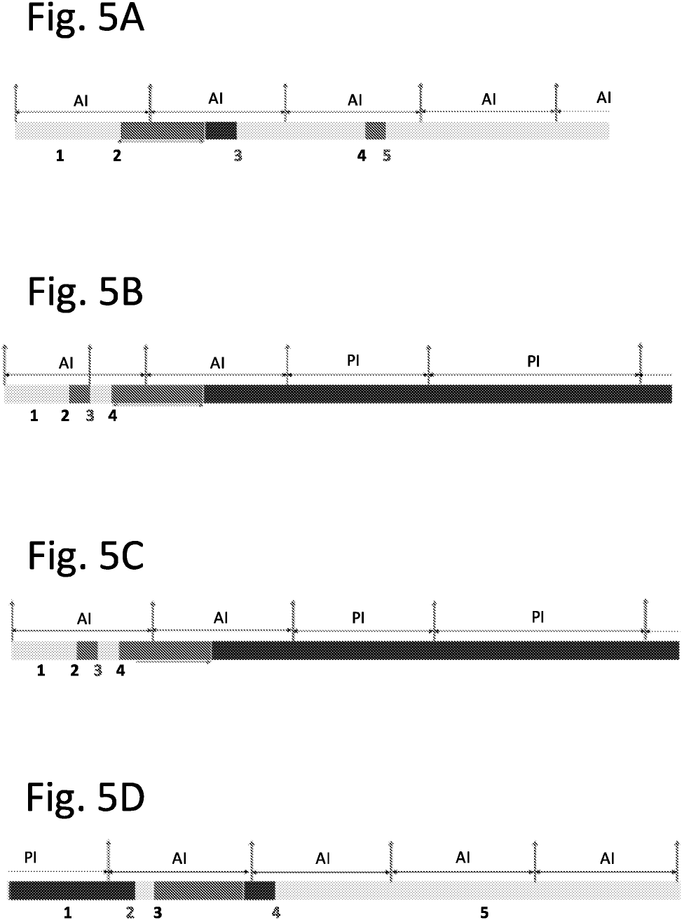

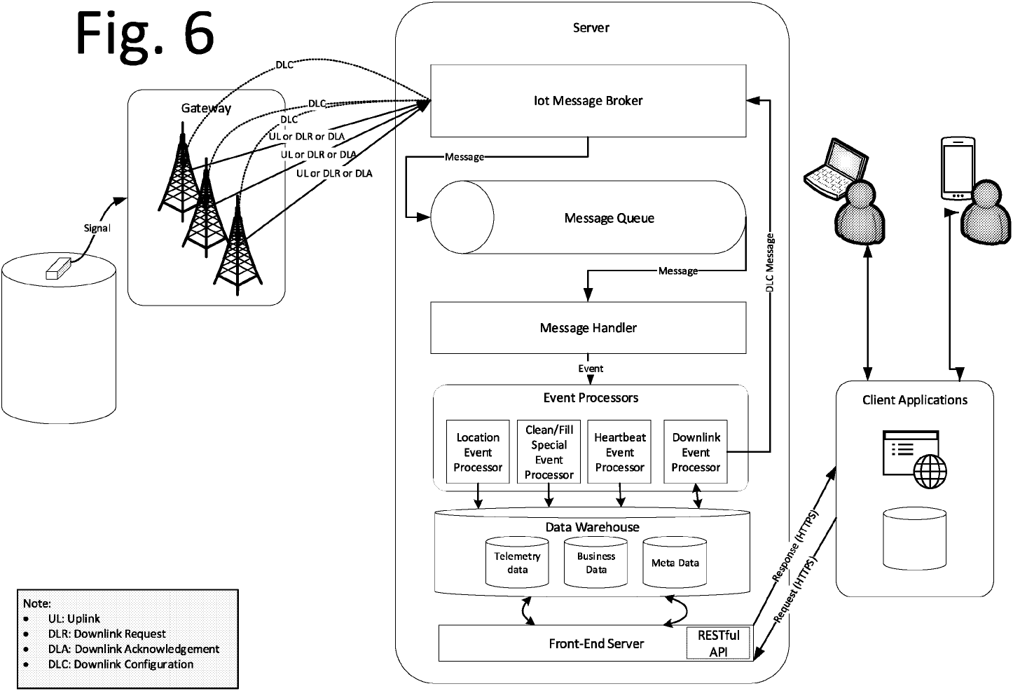

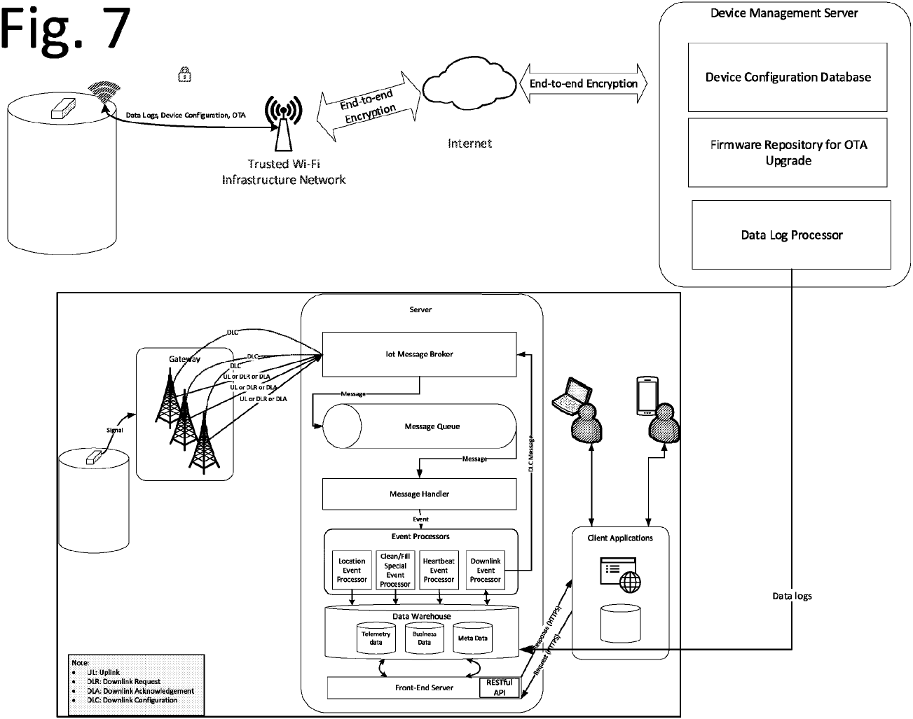

Scenario 1 - Keg in transport: A transport vehicle, such as a truck, may be transporting a keg on which the motion detector is attached. As shown in FIG. 5A, at a first interval, a truck is driving on the road with the kegs (S1), registering translation movement, and the keg is registered as being in the active state. When the truck stops due to traffic for a long period of time (S2), a second interval is entered in which no movement is being registered, but the keg is still in the active state. During this time, the object may enter the passive state, as no movement has been detected. Once the truck starts driving again (S3), the object switches to an active state. If the truck stops in traffic for a short period of time (S4), the keg remains in an active state until the truck starts moving again (S5).

Scenario 2 - Individual keg unloaded from a truck: As shown in FIG. 5B, the truck may be transporting a keg on which the motion detector is attached (S1). The truck then stops at a warehouse (S2), and the keg is unloaded from the truck, which registers a tilting movement (S3). The keg is then stocked in the warehouse (S4). Upon being moved to the warehouse, the motion detector detects no movement and, once the predetermined delay period has passed, the keg enters a passive state.

Scenario 3 - Pallet of kegs unloaded from a truck: As shown in FIG. 5C, the truck may be transporting a plurality of kegs on a pallet (S1). The motion detector may be attached to the pallet, or individual motion detectors may be attached to each of the kegs. The truck then stops at the warehouse (S2), and the pallet of kegs is unloaded from the truck (S3). In this case, as the kegs are on a pallet, no tilt movement is registered, however, a translational movement would be detected by the motion detector, which would stop the predetermined delay period and keep the kegs in an active state (S4). Upon being moved to the warehouse, the motion detector detects no movement and, once the predetermined delay period has passed, the keg enters a passive state.

Scenario 4 - Pallets of kegs loaded in a truck: As shown in FIG. 5D, the pallet of kegs stored in a warehouse are not moving, and are therefore in a passive state (S1). When the pallet of kegs is loaded on to the truck, no tilt movement is registered. However, a translational movement would be detected by the motion detectors, which would switch the kegs to an active state for an active interval (S2). Upon being loaded on the truck, the kegs remain immobile (S3), the motion detector detects no movement and if the predetermined delay period has passed, the keg enters a passive state. Once the truck starts driving (S4), a translational movement is registered by the motion detector, and the kegs enter an active state. The kegs remain in an active state while the truck is driving (S5).

### Sensors

In some embodiments, the device includes a sensor attached to the object. The sensor may include, but is not limited to, a temperature sensor, a humidity sensor, a light sensor, an air flow sensor, a speed sensor, a gyroscope, an inclinometer, and a tilt sensor. In the preferred embodiment, the sensor includes a temperature sensor and is configured to collect temperature measurements for a second data packet. The temperature measurements are indicative of the temperature of the object. Alternatively or additionally, the temperature measurements may be indictive of an environmental temperature around the object. The sensor is operatively associated with the processing unit such that the processing unit can process the second data packet, and transmit a signal to a gateway which includes the second data packet. Alternatively or additionally, the sensor unit may be attached to the processing unit by a flexible printed cable (FPC). In some embodiments, the sensor may be in the form of a sensor board.

The temperature measurements may be utilised in combination with the detected movements to switch between an active state and a passive state. Additionally, temperature measurements may be used in combination with movements to register specific events in which the object is involved. For example, in the context of tracking a container in the form of a keg, the life cycle of a keg includes a cleaning event. The cleaning of a keg may be detected as a cleaning event when a sudden change in temperature and/or specific movements are detected. For example, when the keg is turned upside down, a tilting movement (T180 movement) of about 180 degrees is registered, and triggers the following steps:
The temperature sensor measures an initial temperature (Tmp0);
A temperature threshold is internally set, equivalent to the initial temperature plus a temperature differential threshold (Tmp0 + TD-t);
The device remains passive until the temperature threshold is exceeded;
Once the temperature threshold is exceeded, the temperature sensor measures a secondary temperature (Tmp1);
The time between Tmp0 and Tmp1 is calculated to give a time differential (dTime);
The time differential (dTime) is compared with a temperature differential duration (TD-d);
The device then checks whether:
   ◯ dTime <= TD-d
   ◯ Tmp1 - Tmp0 > TD-t
   ◯ The rotational movement is still registering as about 180 degrees compared to the tilting reference angle (that is, the keg is still upside down);
If all the conditions are satisfied, the device triggers an internal command to start counting a clock;
When the keg is turned back up the right way (that is, the tilt movement is about 0 degrees compared to the tilting reference angle), the temperature sensor measures a final temperature (Tmpf); and
The device then sends an event signal, indicating that a cleaning event has been detected.

### Location

In the preferred embodiment, the tracking device is configured to obtain location information about the object being tracked. The processing unit includes a packet analyser in the form of a wireless sniffer to obtain geolocation information about the object by collecting media access control (MAC) addresses and an associated received signal strength indicator (RSSI) from access points in proximity to the object. It will be appreciated that in some embodiments, the packet analyser may be separate from, but operatively associated with, the processing unit. The proximity to the object may be a predetermined range of distance from the object. The geolocation information may form a third data packet, which can be transmitted to the gateway in the form of a location signal. Alternatively, the third data packet may be included in another signal by the processing unit. The processing unit transmits the MAC addresses collected by the packet analyser at the time of transmitting a signal to the gateway. That is, each time an active state, passive state or movement occurs which triggers a signal, the processing unit collects MAC addresses and RSSIs to obtain geolocation information.

Advantageously, geolocation using WiFi sniffing works both indoors and outdoors and in high density urban areas, and the energy consumption is necessarily lower than that used by GPS technologies.

The MAC addresses and RSSIs can be collected in a number of ways once the processing unit determines geolocation is required upon a signal being triggered.

Variation 1 - more than 2 MAC addresses found: The wireless sniffer identifies access point MAC addresses and their associated RSSIs in proximity to the object. If more than 2 MAC addresses are found, the RSSI values are compared against one another. The processing unit selects the two best RSSI (that is, the two most powerful signals). The two selected signal MAC addresses are compared with historic MAC addresses transmitted by the processing unit. If at least 1 MAC address is different to the historic addresses, the processing unit sends the geolocation information with 2 MAC addresses. If the MAC addresses are the same, then the processing unit only transmits the signal.

Variation 2- Only 1 MAC address found: The wireless sniffer identifies access point MAC addresses and their associated RSSIs in proximity to the object. If only 1 MAC address is found, then the processing unit transmits the geolocation information with the 1 MAC address.

Variation 3 - No MAC addresses found: The wireless sniffer attempts to identify access point MAC addresses and their associated RSSIs in proximity to the object, but cannot find any MAC addresses. In this case, the processing unit only transmits the signal.

The geolocation information may be transmitted as a separate geolocation signal. Alternatively, the geolocation information be included in a third data packet which is then included in the original signal that was triggered.

The following scenarios are provided in the context of tracking a keg through a supply chain. However, it will be appreciated that these scenarios are being used as an example only, and are not intended to limit the use of the tracking device to containers such as kegs.

Scenario 1: Zero previous MAC addresses: The wireless sniffer identifies access points, and finds 3 MAC addresses. The RSSI values are compared and the two best MAC addresses (those with the strongest RSSIs) are stored. The processing unit compares with previous MAC addresses, but finds that there are no previous MAC addresses identified. Accordingly, the processing unit transmits a location signal with the 2 best MAC addresses to the gateway.

Scenario 2: One different MAC address: The wireless sniffer identifies access points, and finds 3 MAC addresses. The RSSI values are compared and the two best MAC addresses are stored. The processing unit compares with previous MAC addresses, and finds that there is 1 different MAC address and 1 MAC address already stored in the processing unit. Accordingly, the processing unit transmits a location signal with the 2 best MAC addresses to the gateway.

Scenario 3: Two different MAC addresses: The wireless sniffer identifies access points, and finds 3 MAC addresses. The RSSI values are compared and the two best MAC addresses are stored. The processing unit compares with previous MAC addresses, and finds that neither of the 2 best MAC addresses have been previously transmitted. Accordingly, the processing unit transmits a location signal with the 2 best MAC addresses to the gateway.

Scenario 4: Same MAC addresses: The wireless sniffer identifies access points, and finds 3 MAC addresses. The RSSI values are compared and the two best MAC addresses are stored. The processing unit compares with previous MAC addresses, and finds that they are the same MAC addresses previously transmitted to the gateway. Accordingly, no location signal is transmitted, as the location has not changed.

### Data Logging

In a preferred embodiment, the processing unit is configured to log object data. Object data may include, but is not limited to timestamps, washing cycles, temperature, tilt events, and acceleration. Object data may also include movement data, activity logs or data from any other sensors or detectors. Object data is logged and stored on the client application. Preferably it is logged for at least 90 days. However, it will be appreciated that that depending on the data and available storage, the historical object data may be logged for more or less time. For examples, in another embodiment the object data may be logged for at least 12 months. In some embodiments, all object data is logged and sent via the client application to an external server or cloud environment. Object data logs may be obtained and accessed via WiFi and/or through the client application.

### Network

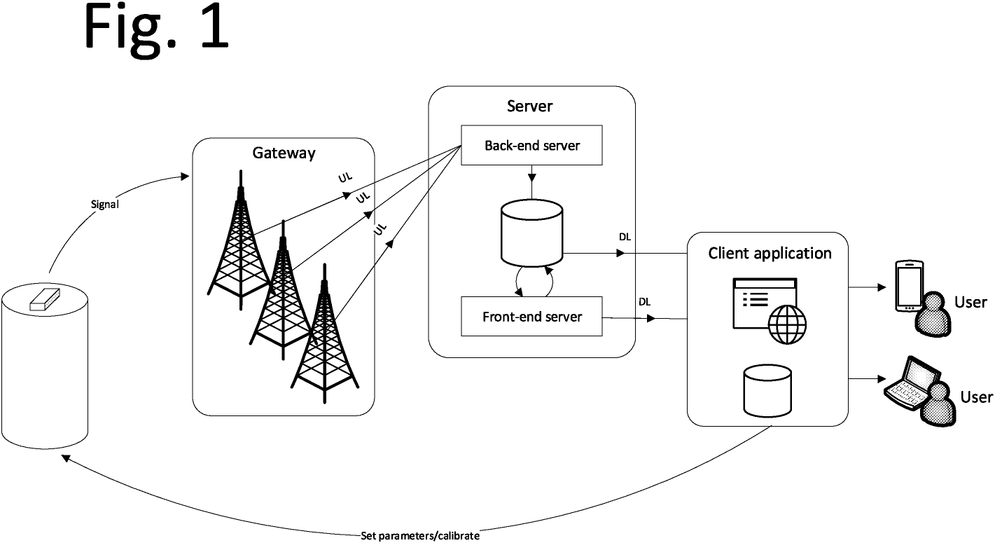

As shown in FIG. 1, the processing unit of the tracking device transmits the signal through a low power wide area network. This network may be a 0G network. Signals are preferably Ultra Narrow Band (UNB) signals, that are transmitted to at least one gateway on a substantially infrequent basis, so as to reduce energy usage, network noise and environmental interference. The signals are typically transmitted to a plurality of gateways, which are preferably base stations with UNB receivers. Signals are transmitted to the gateway in the form of an uplink signal. The base station performs an interference reduction process on the received uplink signal to reduce environmental interference. The interference reduction process may include converting a signal, debugging the signal, and converting it back to its original form to provide a clean signal to be sent to a server. It may also include demodulating the uplink signal. In a preferred embodiment, the interreference reduction process may utilise Differential Phase Shift Keying (DPSK) to reduce interference in the uplink signal.

The base station relays uplink or downlink request signal to the cloud server, where it is processed and stored in at least one database. The server is configured to transmit stored signals as a downlink signal to a client application on request. The server may also transmit stored device specific configuration signal as a downlink configuration signal to the gateway, which is then relayed to the designated device by the gateway. In some embodiments, the downlink signals use Frequency Shift Keying (FSK), to reduce interference in the downlink signal when received by the client application.

In some embodiments, the low power wide area network may be a non-cellular network. The low power wide area network may be an unlicensed or license free low power wide area network. The low power wide area network may utilise a non-cellular network. Advantageously, non-cellular networks offer low power, low bandwidth and low costs compared with cellular networks such as NB-IoT. Unlicensed low power wide area networks do not require SIM cards, which means that there are no costs for administering or replacing SIM cards within the system. Additionally, it is difficult to implement firmware-over-the-air (FOTA) or file transfers using cellular networks, and NB-IoT can result in problems with network and slow cell tower handoffs, so NB-IoT is more suited for static assets rather than roaming assets. In contrast, non-cellular networks work well for devices that transmit infrequently by sending small amounts of data infrequently. It also supports a wide coverage area and base stations can be deployed with ease in areas as needed.

### Network Zone Switching

The network may cover a variety of regional networks, and the device may be compatible with different regions. For example, if the device uses the Sigfox network, the telemetry data of the device could be obtained across the Sigfox regions, including, but not limited to, RC1 (Europe, Oman, South Africa), RC2 (USA, Mexico, Brazil), RC3 (Japan), RC4 (Australia, New Zealand, Singapore, Hong Kong, Columbia, Argentina) and RC5 (South Korea). However, it will be appreciated that the invention is not limited to being compatible with such coverage areas, and varying coverage areas and networks may be used. In one embodiment, where the device uses the Sigfox network, the network is comprised of multiple Sigfox Radio Configuration Zones globally. The device operates with Class 0u certification of radio frequency performance for all Radio Configuration Zone, and preferably for Radio Configuration Zones 1, 2, and 4.

When a device is configured to connect to the Sigfox network, it can only be set to a single zone at any one time. Accordingly, the device needs to be configured to switch zones as necessary to mitigate gaps in global tracking of objects.

To improve global tracking of the device, the device is configured to switch between radio configuration zones. In some embodiments, the zone switching may be performed manually through the client application. Zone switching may be manually set to occur on a particular date, and/or set to occur within a predetermined time frame. Manual zone switching may be configured to broadcast a signal to change a zone configuration of proximal devices. Alternatively or additionally, zone switching may be performed via downlink, where the destination zone and the date are set at a software level. The tracking device may be triggered to perform zone switching at the downlink interval. In further embodiments, zone switching may be performed via a WiFi beacon, in which the zone switch is triggered within the device on receipt of a signal broadcast from the WiFi beacon. Zone switching may be manual or automatic, using one of the following described methods.

Scanning system - The zone switching may be performed using a scanning system which uses dedicated hardware and software. For example, the Sigfox Monarch, system. The device can be configured to scan a specific frame broadcasted by compatible base stations or gateways and change its zone configuration to match the zone of the nearby stations. This process may include the use of chip-on-board technology within the device. Chip-on-board (COB) is a circuit board manufacturing method where components are wired and bonded directly to a PCB before being covered with epoxy. This approach allows the design and manufacturing of only the necessary components for a more compact and less costly PCBA. Accordingly, a COB may be utlised within the tracking device which includes the firmware of the tracking device and the Sigfox Monarch module.

Manual zone switching - Manual zone switching may be performed using the NFC tag embedded in the device. By connecting the NFC tag from the device to the client application, it is possible to also perform and/or trigger zone switching. For example, manual zone switching may perform the following steps:
i) Place a terminal device with the client application close to the NFC tag of the WiFi beacon to create a communication channel between the two devices;
ii) The client application then displays a list of actions that can be performed. “Zone Switch” is selected.
iii) The destination zone that the object will be travelling to is chosen;
iv) The date that the object is expected to arrive at the destination zone (that is, the date form which the switch will need to be effective) is chosen; and
v) Feedback from the client application will confirm success or failure of the action.

Optionally, a Downlink Request message can be sent to pass the information to the platform and keep a common behaviour with the zone switch via a Downlink Configuration message.

Zone switching via downlink - Zone switching via downlink is another option to limit manual operations of the setting the destination zone. For example, downlink zone switches may perform the following steps:
i) The destination zone and zone switch date are set on the software system for the batch of objects which have been identifies to be shipped to a destination zone;
ii) At the downlink interval, the downlink configuration message is received by a device or a group of devices;
iii) An acknowledgement Downlink Acknowledgement Message is sent from the devices to confirm the zone switch was successful.; and
iv) The device triggers the zone switch at the zone switch date that was sent through from the Downlink Configuration Message;

This method may also be used to complement the Zone switch via NFC to limit time spent by operators configuring the devices before a shipment.

Zone switching via a timer - As many objects are shipped internationally by maritime freight, they will likely be within a cargo ship and likely out of reach from any base stations for varying period of time (between 10 days to 3 weeks or more). Accordingly, it may also be possible to use a failed or unreceived downlink to trigger Monarch scans,

Zones switching via a WiFi beacon - Zones switching may also be performed by using an external device that broadcasts a specifically designed WiFi SSID for each shipping pallet. For example, the zone switching via a WiFi beacon may perform the following steps:
i) Place a terminal device with the client application close to the NFC tag to create a communication channel between the two devices;
ii) The client application then displays a list of actions that can be performed. “Zone Switch” is selected;
iii) The destination zone that the object will be travelling to is chosen;
iv) The date that the object is expected to depart and arrive at the destination zone (that is, the date form which the switch will need to be effective) is chosen;
v) An external WiFi beacon is installed in the shipping pallet;
vi) The WiFi beacon starts broadcasting a special SSID (that integrates the destination zone code) at a predetermined time after the date of shipment;
vii) The devices perform their normal WiFi scan and detect the WiFi beacon SSID; and
viii) Based on the detected WiFi SSID, the devices change their zone configuration.

As such, when the kegs arrive at their destination zone, they are already set to the right Radio Configuration Zone and can immediately start tracking.

Zone switching via a master tracking device - The master tracking device method uses the same logic as the above-described WiFi beacon method. However, instead of using a WiFi beacon, one of the tracking devices mounted on an object to be shipped is configured as a “master” tracking device. The other tracking devices in the shipping pallet would maintain their normal behaviour. Zone switching via a master tracking device may perform the following steps:
i) Place a terminal device with the client application close to the NFC tag of the master tracking device to create a communication channel between the two devices;
ii) The client application then displays a list of actions that can be performed. “Zone Switch” is selected;
iii) The destination zone that the object will be travelling to is chosen;
iv) The date that the object is expected to depart and arrive at the destination zone (that is, the date form which the switch will need to be effective) is chosen;
v) The master tracking device starts broadcasting a special SSID (that integrates the destination zone code) at a predetermined time after the date of shipment;
vi) The other tracking devices perform their normal WiFi scan and detect the master tracking device WiFi SSID;
vii) Based on the detected WiFi SSID, the tracking devices change their zone configuration; and
viii) The master tracking device changes its zone after broadcasting.

### Client Application

A client application may be, for example, a smartphone application or a web browser. The client application is configured to receive downlink signals from the server, indicative of information received from the tracking device. In this way, a user is able to receive information relating to the object being tracked, including, but not limited to, whether the object is in an active or passive state, measurements collected by the motion detector, events involving the object, sensor measurements and location information. In the context of the example of tracking a container such as a keg, a user can see where the keg is located, whether it is being moved or is in storage, when it has been cleaned, and also any temperature and accelerometer measurements collected by the device.

The client application can also be used for additional functionalities, such as enabling a user to wirelessly calibrate variables of the tracking device, including intervals and thresholds. In some embodiments, the device includes an NFC tag, configured to connect with the client application. The NFC tag includes unique identifying information enabling a link between the client application and the tracking device. The NFC tag can be used to set parameters and/or thresholds for a specific tracking device. In other embodiments, the device may include Bluetooth connectivity for connecting to a client application. The NFC tag and/or Bluetooth connectivity may be used to facilitate update of firmware. For some actions, such as performing zone switching, the wireless connection with the client application may be used to update firmware of a plurality of proximal devices, by using the connected device as a primary WiFi beacon.

Once connected to the tracking device, the client application is enabled to activate the tracking device or deactivate the tracking device, calibrate the device, including calibrating the accelerometer, setting a tilting reference angle and a rotational reference angle, changing the network parameters, manually trigger a downlink request signal by forcing a request for a downlink configuration signal from the device to the server, manually trigger a location signal by forcing the wireless sniffer to obtain geolocation information and send a location signal, manually trigger a temperature signal by forcing the temperature sensor to collect temperature data and send a temperature signal, and manually trigger an event signal by forcing the device to send an event signal indicating the number of hours since the last event occurred.

In a preferred embodiment, the device includes a housing which forms an enclosure around at least the motion detector and the processing unit. The housing is substantially rectilinear, and includes an upper housing and a lower housing. In some embodiments, the upper housing is substantially rectilinear and the lower housing is substantially planar, forming a base. In other embodiments, the upper housing and the lower housing may be substantially the same shape. The upper housing and the lower housing are attachably detachable from one another.

The housing is configured to be removably attached to the object. In a preferred embodiment, the housing has a first pair of tabs extending from each end of the upper housing, and a second pair of tabs extending from each end of the lower housing, the first and second pair of tabs configured to abut when the upper and lower housing are connected with each of the tabs configured for affixing the housing to a mount. The first and second pair of tabs each include a first aperture and a second aperture respectively, the first and second apertures configured to align when the first pair of tabs and second pair of tabs abut with each other. In some embodiments, the second apertures include a thread.

In another embodiment, the housing may be substantially capsule-shaped. The upper housing and the lower housing may both be substantially semi-capsule shaped. In some embodiments, the semi capsule-shaped lower housing may have a substantially flat base to facilitate mounting.

In some embodiments, the housing may include a reservoir defining a thin portion of the housing to accommodate an LED light, which is visible through the material of the housing. The operation of the LED light is used to indicate a low battery, and is only displayed when the object is moving so as to reduce battery usage. The active state or detection of a specific movement type can be used to trigger the display of the LED light.

In further embodiments, the housing may include an aperture configured to accommodate a sensor. The aperture may be enclosed by a metal cover. The mount is configured to be fixedly attached to the object. Preferably, the mount is a substantially u-shaped bracket, configured to be welded to the object.

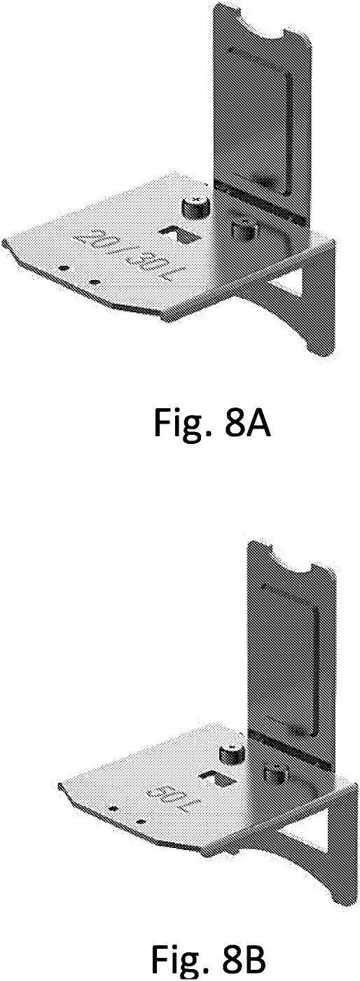

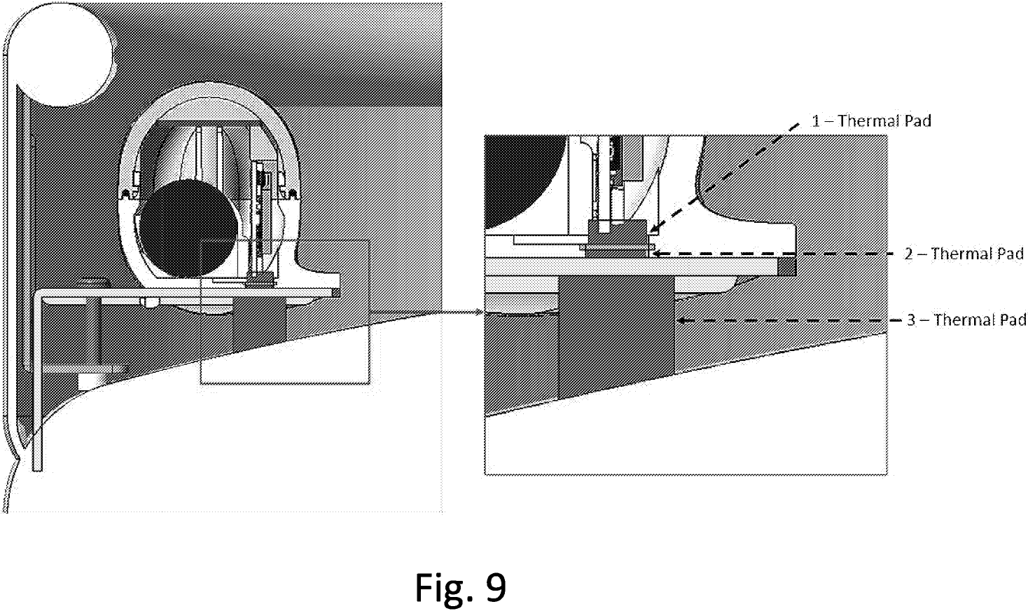

In another embodiment, the mount may be a bracket. The bracket may include a pair of substantially L-shaped interlocking brackets, adapted to be installed on an object. For example, as shown in FIGS. 8A and 8B, the pair of interlocking brackets may be configured to be mounted on a 20L, 30L of 50L keg. The two interlocking brackets may be secured together using a pair of screws. The interlocking brackets are configured to mate together to provide a mounting surface on which the housing of the tracking device can be attached. In some situations, the mounting surface may be spaced apart from the object to define a gap. As shown in FIG. 9, this gap may be filled by an external thermal pad, which is disposed between the object and the device. Additional thermal pads may be placed within or around the device housing. For example, between the temperature sensor and the metal cover, and between the metal cover and the mount to fill any gaps and facilitate thermal transfer between the temperature sensor and the object. The bracket applies pressure to the external thermal pad to secure the thermal pad in place. In a preferred embodiment, the device is mounted such that is meets an IK10 impact protection rating.

The device further includes an A size lithium battery. In some embodiments, the battery is connected to the processing unit via a connector, to facilitate ease of connection and disconnection of the battery. The connector may include a flexible length of cord or wire. The battery life of the tracking device is estimated to last up to 7 years taking into account the following actions per day: 5 wireless sniffing actions, 5 temperatures measurements, 10 translational movement detections, 5 uplink signals and 0.1 downlink signals. It will be appreciated that variations of different actions per day can increase or decrease the battery life. However, the device is configured to utilise substantially less power than traditional tracking devices, thereby extending battery life compared with traditional tracking devices.

### Tracking Device In Use

The following description describes the use of the tracking device for tracking a beer keg.

First, a mount is welded to the beer keg to be tracked. The housing of the tracking device is then attached to the mount. Once the device is attached to the beer keg, activation and calibration is performed. A QR Code is disposed on the beer keg to be tracked. A smart phone application is used to scan the QR Code on the beer keg, and confirm a Keg ID associated with the beer keg. Next, the smart phone application is used to connect the smart phone with an NFC tag disposed within the housing of the tracking device. Once the unique Beacon ID is picked up from the NFC tag, the beacon ID is confirmed, and the Keg ID and the Beacon ID are linked together, thereby activating and initialising the tracking device. Once initialised, the details and data of the tracking may be sent to a recipient email address. This process can be used to initialise a plurality of beer kegs with tracking devices, so as to track a batch of beer kegs.

The tracking device is awakened in a passive state. The user may then configure various settings and/or parameters of the device using the smart phone application. The reference angles are set to 0 degrees, and the thresholds for motion detection are also set at this stage. Once activated and calibrated, the beer keg is ready to be tracked.

In one example, a beer keg is sent to a customer for rental. The customer initialises and calibrates the tracking device for the beer keg, as above. The keg is then filled with the customer’s beer product, and transported to a secondary location. As the beer keg is loaded onto a transportation vehicle, such as a truck, for transport to the secondary location, the accelerometer measures translational (T0) movement and a tilting (T180) movement. The movement detection triggers a signal to be sent from the processing unit to a base station, indicating that the keg has moved and is in an active state. Once loaded onto the track and being transported to the secondary location, the tracking device detects that there is translational (T0) movement occurring as the truck moves, triggering a signal to be sent to the base station, indicating that the keg is still in an active state. This translational movement keeps the keg in an active state. Once the truck reaches the secondary location, the keg is unloaded from the truck, where a tilting (T180) movement is detected, triggering a further signal indicating that the keg is an active state.

Once unloaded the keg is placed in a cool room at the secondary location. After a period of time in the cool room, the accelerometer has detected no movement from the keg, and a signal is sent to the base station that the keg is now in a passive state. At predetermined intervals, the keg continues to send a signal indicating that it remains in the passive state.

Once the signals are transmitted to a base station, they are then sent to a server, and the client application may receive the signal information about the state of the keg, and other tracking data, from the server. When the signals are transmitted to the base station whilst the keg is in an active state or a passive state, the wireless sniffer obtains location information about the keg by sniffing out access points in proximity to the keg, and transmitting the location information along with any triggered signals. In this way, a user is able to see information about the keg’s location when the tracking device detects any changes in the state of the keg.

The temperature sensor may additionally collect information about the temperature of the beer keg, or its surrounding environment. For example, the tracking device may register a decrease in temperature from the temperature sensor, but detect no movement of the keg, indicating that the keg is being stored in a cool room. Alternatively, the tracking device may register an increase in temperature while also detecting that the keg has been flipped upside down (registering a T180 movement). In this case, this would indicate that the keg is currently being cleaned, which would trigger transmission of an event signal.

As the keg is being stored, it may be subject to minor movements. The thresholds for movement to be detected which were set during the calibration phase will prevent the tracking device from registering these minor movements and falsely triggering the transmission of a signal indicating an active state. Once the keg is moved from the cool room storage to be emptied, the motion detector detects movement, stopping the passive state and triggering a signal indicating that the keg has switched from a passive state to an active state. Once emptied, the keg is loaded back onto a truck, registering rotational or tilting movement and triggering a signal indicating an active state. The keg may then be transported back to the original location (or any other location). At any time during the life cycle of the keg, the smart phone app can be used to manually trigger the tracking device to transmit a signal so as to obtain a location or temperature measurement at the request of a user.

At the end of the keg’s life cycle, the tracking device can be removed from the mount to be repaired, upgraded or replaced. The battery of the tracking device can also be easily replaced by removing the tracking device from the mount and separating the upper and lower housing to reveal the battery for replacement. Once the battery is replaced, the upper and lower housing can be re-engaged, and the tracking device re-attached to the mount.

### Advantages

The tracking device and system described herein is particularly useful for tracking unpowered objects. Power consumption is significantly reduced by utilising a low power wide area network to transmit signals including collected data at infrequent intervals using specific triggers, and collecting location information via wireless sniffing. This also extends the life cycle of the tracking device, reducing the need to regularly replace the device, or its battery. The specific design of the device as used on kegs also facilitates replacement and upgrade of the device at the end of its useful life, where the mount remains attached to the keg, while the device can be removed and replaced.

The use of wireless sniffing and range of the network also allows the location and status of an object to be determined even when the object enters signal restricted areas, such as cold rooms, underground storage rooms or remote areas, where wireless communication and tracking is traditionally difficult. The determination of location data reduces potential loss of objects in a supply chain, increases object utilisation, reduces the size of the fleet required, and enables quick identification and location of object, which is useful for situation such as product recalls. The combination of wireless sniffing and low power network also provide accurate geolocation data at a significantly reduced price compared with 2G to 5G networks.

Advantageously, the tracking device can be paired with a client application such as a smart phone app to track not only individual objects but also batches of objects. The use of a Near Field Communication tag to create a wireless connection between the client application and the tracking device enables firmware to be updated through the network, without relying on Bluetooth.

The inclusion of a temperature sensor allows an end user to track how an object is handled and understand the various conditions that it is subjected to through the supply chain. This is particularly beneficial for objects such as food and beverage products, which require specific storage conditions.

Although the invention has been described with reference to specific examples it will be appreciated by those skilled in the art that the invention may be embodied in many other forms.

1. A tracking device for an object, the tracking device including:
a motion detector attachable to the object, the motion detector being configured to collect a first data packet which is indicative of a movement of the object; and
a processing unit operatively associated with the motion detector such that the processing unit can process the first data packet to determine whether the object is in one of an active state and a passive state;
wherein the processing unit can transmit a signal indicative of the state of the object to at least one gateway;
wherein the processing unit includes a packet analyser, configured to obtain geolocation information about the object.

2. (canceled)

3. The tracking device according to claim 1, wherein the device includes a housing, forming an enclosure around at least the motion detector and the processing unit.

4. The tracking device according to claim 3 wherein the housing is substantially capsule-shaped.

5. The tracking device according to claim 1, wherein the motion detector includes an accelerometer.

6. The tracking device according to claim 1, wherein the active state is determined by at least one movement of the object detected by the motion detector.

7. The tracking device according to claim 6 wherein the at least one movement triggers a signal including the first data packet.

8. The tracking device according to claim 1, wherein the signal is transmitted at a predefined interval.

9. The tracking device according to claim 1, wherein the device includes a sensor configured to collect a second data packet including data representative of one or more characteristics of the object and/or one or more parameters associated with a condition of the environment in which the object is located.

10. The tracking device according to claim 8 wherein the sensor includes a temperature sensor.

11. The tracking device according to claim 9, wherein the device includes at least one thermal pad disposed at a location between the temperature sensor and the object, so as to allow thermal transfer between the temperature sensor and the object.

12. The tracking device according to claim 1, wherein the processing unit transmits the signal through a low power wide area network at substantially infrequent intervals.

13. The tracking device according to claim 11, wherein the processing unit is configured to switch between zones within low power wide area network.

14. The tracking device according to claim 1, wherein the device includes an NFC tag, configured to enable a wireless connection with a client application.

15. The tracking device according to claim 14, wherein the wireless connection with the client application can be used to perform at least one of the following actions: activate the device, calibrate the device, set parameters and/or thresholds for the device, switch radio configuration zones and update firmware.

16. The tracking device according to claim 1, wherein the device includes a mount, configured to be fixedly attached to the object.

17. The tracking device according to claim 16, wherein the mount includes a pair of substantially L-shaped interlocking brackets, configured to mate together to provide a mounting surface on which the device can be mounted.

18. The tracking device according to claim 17, wherein the device is detachably attachable to the mount.

19. A system for tracking an object, the system including:
a tracking device including:
a motion detector attachable to the object, the motion detector being configured to collect a first data packet which is indicative of a movement of the object; and
a processing unit operatively associated with the motion detector such that the processing unit can process the first data packet to determine whether the object is in one of an active state and a passive state;
wherein the processing unit can transmit a signal indicative of the state of the object to at least one gateway;
wherein the processing unit includes a packet analyser, configured to obtain geolocation information about the object;
at least one server in communication with the at least one gateway, the server configured to receive an uplink signal from the at least one gateway; and
a client application in communication with the server, the client application configured to receive a downlink signal from the server.

20. A method for tracking an object, the method including the steps of:
a) collecting a first data packet which is indicative of a movement of the object;
b) processing the first data packet to determine whether the object is in one of an active state or a passive state;
c) obtaining geolocation information about the object from a packet analyser;
d) transmitting a signal indicative of the state of the object and the geolocation information to at least one gateway;
e) receiving an uplink signal from the at least one gateway to at least one server; and
f) receiving a downlink signal from the server to a client application..
